(19) United States
(12) Patent Application Publication
(10) Pub. No.: US 2026/0361188 A1
(43) Pub. Date: Nov. 12, 2026

(54) BEARING SYSTEM INCLUDING A GROUNDING BRUSH ASSEMBLY

(71) Applicant: AKTIEBOLAGET SKF, GOTEBORG (SE)

(72) Inventors: Benoit ARNAULT, Saint-Cyr-sur-Loire (FR); Mickael CHOLLET, Joue-Les-Tours (FR)

(21) Appl. No.: 19/660,769

(22) Filed: Apr. 28, 2026

(30) Foreign Application Priority Data
May 6, 2025 (FR) FR2504792

(51) Int. Cl. H02K 11/40; F16C 19/06; H01R 39/38; H02K 5/173

(52) U.S. Cl. CPC H02K 11/40; F16C 19/06; H01R 39/385; H02K 5/173; F16C 2380/26

(57) ABSTRACT

The bearing system includes a bearing provided with an inner ring and an outer ring, and a grounding brush assembly having a brush provided with a plurality of conductive fibers and a holder inside of which the conductive fibers are mounted. The brush also includes a mounting plate on which the holder is mounted and which is fastened to the outer ring of the bearing. The conductive fibers extend protruding relative to the holder in the axial direction.

### CROSS-REFERENCE

This application claims priority to French patent application no. 2504792 filed on May 6, 2025, the contents of which are fully incorporated herein by reference.

### BACKGROUND OF THE INVENTION

The present invention relates to the general field of grounding devices for controlling the shaft current generated in motors or electric machines, and in particular grounding brush assemblies.

In a motor or electric machine, at least one roller bearing is mounted between the housing of the motor or electric machine and the rotary shaft in order to support the shaft.

During operation, when the shaft is rotating, an electric potential difference can occur between the shaft and the housing of the motor or electric machine, which generates an electric current between the inner ring of the roller bearing, which is rigidly connected to the shaft, and the outer ring rigidly connected to the housing.

The electric current passing through the components of the roller bearing can damage the components, in particular the rolling elements and the raceways formed on the inner and outer rings. These electric discharges can also generate vibrations.

In order to overcome these drawbacks, it is known practice to earth or ground the rotary shaft using a grounding brush comprising conductive fibers. The grounding brush is generally mounted in the orifice or bore of the housing of the electric motor so that the free ends of the fibers are in radial contact with the outer surface of the rotary shaft.

Due to the conductivity of the fibers, the brush is maintained at the same electric potential as the housing of the electric motor. The inner and outer rings of the roller bearing are also at the same electric potential, which reduces or even eliminates the problematic electric discharges through the roller bearing.

US patent publication no. 2021/0021180A discloses a grounding brush assembly comprising a grounding brush provided with a plurality of conductive fibers, a holder inside which the conductive fibers are mounted, and an annular mounting plate comprising a plurality of tabs for retaining the holder radially and axially and an annular outer flange radially surrounding the brush and the tabs.

It is also possible to provide the roller bearing with the grounding brush assembly.

For an electric motor having a reduced radial footprint between the housing and the rotary shaft, a roller bearing with a small radial dimension is typically used.

In this case, it is not possible to use a grounding brush assembly with standard dimensions, as the total radial footprint of the holder and the fibers is too large relative to the footprint of the bearing.

The present invention aims to overcome this drawback.

### SUMMARY OF THE INVENTION

The invention relates to a bearing system comprising a bearing provided with a first ring and a second ring capable of rotating relative to each other.

The system also comprises a grounding brush assembly comprising a brush provided with a plurality of conductive fibers, and a holder inside which the conductive fibers are mounted.

The grounding brush assembly further comprises a mounting plate on which the holder is mounted and which is fastened to one of the inner and outer rings of the bearing.

According to one general feature, the conductive fibers of the brush of the grounding brush assembly extend protruding relative to the holder in the axial direction.

“Axial direction” is given to mean the direction parallel to the axis of the bearing. The conductive fibers of the brush can extend protruding axially relative to the holder in the axial direction. The conductive fibers can extend protruding obliquely relative to the holder in the axial direction. Alternatively, some of the conductive fibers of the brush can extend protruding axially relative to the holder in the axial direction and the rest of the conductive fibers of the brush can extend protruding obliquely relative to the holder in the axial direction.

In other words, the conductive fibers of the brush are oriented horizontally or substantially horizontally.

For a bearing with a small radial dimension, this orientation of the conductive fibers makes it possible to use a grounding brush assembly with standard dimensions without increasing the friction torque generated by the fibers when the assembly is used in the associated electric motor.

The grounding brush assembly can extend partially outside the bearing. Preferably, the part of the assembly positioned outside of the bearing is offset radially inwardly relative to a front face of the outer ring and offset radially outwardly relative to a front face of the inner ring.

The part of the assembly positioned outside the bearing thus leaves the front face of the outer ring free and leaves the front face of the inner ring free, and they can thus be used as support or stop surfaces.

According to a first design, the conductive fibers of the brush of the grounding brush assembly extend protruding relative to the holder axially away from the bearing.

According to a second alternative design, the conductive fibers of the brush extend protruding relative to the holder axially towards the bearing.

Advantageously, the holder of the grounding brush assembly defines an axially open channel.

In one embodiment, the mounting plate of the grounding brush assembly comprises a mounting skirt and a plurality of tabs for retaining the brush holder of the grounding brush assembly, the holder being centered radially between the mounting skirt and the retaining tabs.

In one embodiment, the mounting plate of the grounding brush assembly is fastened directly to the inner or outer ring of the bearing without interposing an intermediate element. Alternatively, the mounting plate could be fastened with an intermediate element, but this increases the total cost of the system.

Preferably, the mounting plate is fastened inside a groove formed in the orifice of the outer ring of the bearing or formed on the outer surface of the inner ring of the bearing. Alternatively, the plate can be fastened to another zone of the inner or outer ring of the bearing, for example on a front face, with or without interposing an intermediate element.

In one embodiment, the mounting plate is fastened to the outer ring of the bearing. Alternatively, the mounting plate can be fastened to the inner ring of the bearing.

Preferably, the mounting plate is made in one piece.

Advantageously, the system further comprises a flange fastened to the other of the inner or outer ring of the bearing and with which the free ends of the conductive fibers of the brush of the grounding brush assembly are in contact. The flange is a separate element from the inner or outer ring and fastened to it by any appropriate means, for example by rolling, clamping, gluing, bonding, snap-fitting, etc.

Alternatively, provision can be made for the inner or outer ring to be provided with a protuberance or collar integrally formed with the rest of the inner or outer ring and against which the free ends of the conductive fibers of the brush rub.

In another variant, the flange can be mounted on the shaft of the associated electric motor.

The flange can comprise a collar or radial portion with which the free ends of the conductive fibers are in contact.

Preferably, the flange is made in one piece.

In one particular embodiment, the bearing of the system comprises at least one row of rolling elements positioned between raceways of the first and second rings. Alternatively, the bearing could be a plain bearing.

The invention also relates to an electric motor comprising a housing, a shaft and at least one bearing system as defined above and mounted radially between the housing and the shaft.

### BRIEF DESCRIPTION OF THE SEVERAL VIEWS OF THE DRAWINGS

The present invention will be better understood on reading the detailed description of embodiments given by way of non-limiting example and illustrated by the appended drawings, in which:

FIG. 1 is a perspective view of a bearing system according to one exemplary embodiment of the invention;

FIG. 2 is a front view of the bearing system in FIG. 1;

FIG. 3 is a cross-sectional half-view along the line III-III in FIG. 2;

FIG. 4 is a cross-sectional half-view along the line IV-IV in FIG. 2;

FIG. 5 is a perspective view of a mounting plate of the bearing system in FIGS. 1-4 in the unmounted state and before a crimping operation;

FIG. 6 is a perspective view of the mounting plate in FIG. 5 and a grounding brush in the unmounted state and before the crimping operation;

FIG. 7 is a cross-sectional half-view of FIG. 6;

FIG. 8 is a perspective view of the mounting plate and the grounding brush in FIG. 6 in the unmounted state and after the crimping operation;

FIG. 9 is a cross-sectional half-view of FIG. 8;

FIG. 10 is a cross-sectional half-view schematically illustrating the mounting of the bearing system in FIG. 1 inside an electric machine housing;

FIG. 11 is a perspective view of a bearing system according to another exemplary embodiment of the invention;

FIG. 12 is a front view of the bearing system in FIG. 11;

FIG. 13 is a cross-sectional half-view along the line XIII-XIII in FIG. 12;

FIG. 14 is a perspective view of a mounting plate and a grounding brush in the unmounted state and before a crimping operation;

FIG. 15 is a cross-sectional half-view of FIG. 14; and

FIG. 16 is a perspective view of the mounting plate and the grounding brush in FIG. 13 in the unmounted state and after the crimping operation.

### DETAILED DESCRIPTION OF THE INVENTION

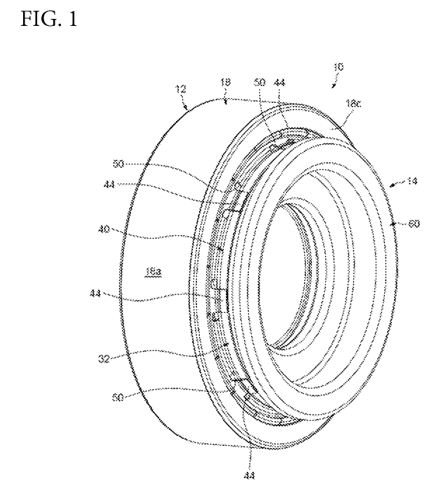

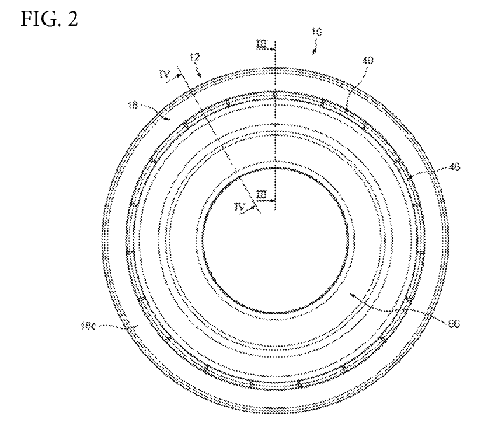

The bearing system illustrated in FIGS. 1-4 and denoted by reference sign 10 as a whole is intended to be mounted radially between a housing and a rotary shaft of a motor or electric machine.

The bearing system 10 comprises a bearing 12 and a grounding brush assembly 14 mounted on the bearing 12.

The bearing 12 is provided with a first inner ring 16 and a second outer ring 18 that are capable of rotating relative to each other about the axis (not shown) of the bearing 12. The inner and outer rings 16, 18 of the bearing 12 are concentric and extend axially along the axis of the bearing 12. The inner and outer rings 16, 18 are made from steel. The rings 16, 18 are of the solid type.

In the exemplary embodiment shown, the bearing 12 also comprises a row of rolling elements 20, preferably balls, radially interposed between the inner and outer rings 16, 18. The bearing 12 also comprises a cage 22 for maintaining the even circumferential spacing of the rolling elements 20.

The inner ring 16 comprises a cylindrical orifice 16a, a cylindrical axial outer surface 16b radially opposite the orifice 16a, and opposite radial first and second front faces 16c, 16d axially defining the orifice 16a and the outer surface 16b. The orifice 16a and the outer surface 16b define the radial thickness of the inner ring 16. The front faces 16c, 16d define the axial length of the inner ring 16.

The outer ring 18 comprises a cylindrical axial outer surface 18a, a cylindrical orifice or bore 18b radially opposite the outer surface 18a, and opposite radial first and second front faces 18c, 18d axially defining the orifice 18b and the outer surface 18a. The outer surface 18a and the orifice/bore 18b define the radial thickness of the outer ring 18. The faces 18c, 18d define the axial length of the outer ring 18.

The outer ring 18 further comprises first and second annular grooves 24, 26 formed in the orifice or bore 18b and extending radially outwardly. Each groove 24, 26 is oriented radially toward the inner ring 16.

The grooves 24, 26 are positioned axially on either side of the row of rolling elements 20. The groove 24 is situated axially in the vicinity of the front face 18c of the outer ring 18 and the groove 26 is situated axially in the vicinity of the front face 18d. The grooves 24, 26 are symmetrical with respect to each other relative to the radial mid-plane of the bearing system. Alternatively, the outer ring 18 could comprise only the one groove 24.

The grounding brush assembly 14 is fastened in the groove 24 of the outer ring 18 of the bearing 12. The assembly 14 has a generally annular shape.

The assembly 14 partially extends axially outside the bearing 12. The part of the assembly 14 positioned outside the bearing 12 is offset radially inwardly relative to the front face 18c of the outer ring 18 and offset radially outwardly relative to the front face 16c of the inner ring 16. In other words, the part of the assembly 14 positioned outside the bearing 12 is situated in the axial continuation of the radial space delimited between the orifice/bore 18b of the outer ring 18 and the outer surface 16b of the inner ring 16. The assembly 14 leaves free the front face 18c of the outer ring 18 and the front face 16c of the inner ring 16.

The assembly 14 comprises a grounding brush 30 and a brush mounting plate 40 configured to center the brush 30. The mounting plate 40 supports the brush 30. The mounting plate 40 is fastened in the groove 24 of the outer ring 18 of the bearing 12.

In the exemplary embodiment illustrated, the brush 30 extends axially outside the bearing 12. Alternatively, the brush 30 could be partially housed inside the inner and outer rings 16, 18 of the bearing 12 and partially extend axially outside the bearing 12.

The brush 30 comprises a plurality of individual conductive fibers 31. The conductive fibers 31 can be made from carbon, stainless steel or conductive plastics such as acrylic or nylon fibers. The conductive fibers 31 are not shown in FIG. 1.

The brush 30 further comprises a holding member or holder 32 inside of which the conductive fibers 31 are mounted. The conductive fibers 31 extend protruding relative to the holder 32 with respect to the axis of the bearing 12. The conductive fibers 31 extend protruding axially away from the bearing 12. The holder 32 defines the inner diameter of brush 30. The holder 32 is radially offset outwardly relative to the inner ring 16 and radially offset inwardly relative to the outer ring 18.

In the exemplary embodiment illustrated, the holder 32 is in the form of an open ring. The holder 32 is made from a rigid material. The holder 32 can be made by cutting and stamping. The holder 32 is made from an electrically conductive material, such as for example aluminum, stainless steel, bronze, copper or another material. Alternatively, the holder 32 can be made from an electrically non-conductive material with a conductive coating or a conductive paint.

The brush 30 also preferably comprises a ring 33 around which the conductive fibers 31 are positioned inside the holder 32. The ring 33 performs a function of supporting the conductive fibers 31. The ring 33 is mounted inside the holder 32.

The holder 32 of the brush 30 comprises a radial mounting portion 34 and two opposite lateral walls 36, 38 extending outwards from the mounting portion 34 and radially clasping the conductive fibers 31. The conductive fibers 31 rest radially on either side against the lateral walls 36, 38. The conductive fibers 31 rest axially against the mounting portion 34. The conductive fibers 31 extend protruding outwardly relative to the lateral walls 36, 38 of the holder 32.

The mounting portion 34 and the two lateral walls 36, 38 define a channel that is axially open on the outer side (i.e., faces open in the axial direction) and inside of which the conductive fibers 31 are partially situated or disposed.

The lateral wall 32 continues on from one end of the mounting portion 34 and the lateral wall 38 continues on from the opposite end thereof. The lateral walls 36, 38 extend obliquely inwardly from the mounting portion 34. The lateral walls 36, 38 are symmetrical with each other relative to an axial mid-plane of the holder 32. Alternatively, just one of the two lateral walls 36, 38 could extend obliquely inwardly. In another variant, both lateral walls 36, 38 could extend axially. Preferably, the mounting portion 34 extends substantially radially. Alternatively, the mounting portion 34 may extend obliquely.

The annular brush 30 shown is not open. Alternatively, the ring can be open. This makes it possible to adapt the brush 30 to different diameters of the shaft of the motor. In general, the ends of the brush 30 are not fastened to each other. As a variant, the ends of the brush 30 could be fastened to each other.

The holder 32 is mounted on the mounting plate 40. The mounting plate 40 comprises an annular radial portion 42 and a plurality of tabs 44 for retaining the brush 30 extending from the radial portion 42.

The mounting plate 40 also comprises a fastening portion 46 extending from the radial portion 42 and fastened in the groove 24 of the outer ring 18 of the bearing. The fastening portion 46 extends from a large diameter edge of the radial portion 42.

The mounting plate 40 further comprises a mounting skirt 48 extending axially from the radial portion 42. The mounting skirt 48 extends from a small diameter edge of the radial portion 42. The mounting skirt 48 extends protruding axially relative to the radial portion 42 in a direction away from the rolling elements 20.

The holder 32 of the brush 30 rests axially against the radial portion 42 of the mounting plate 40. More specifically, the mounting portion 34 of the holder 32 rests axially against the radial portion 42. The holder 32 rests axially against the radial portion 42 axially away from the rolling elements 20. The radial portion 42 is housed axially inside the bearing 12. The radial portion 42 extends radially toward the inner ring 16 while remaining at a distance from it, i.e., is spaced from inner ring 16. The radial portion 42 has a stepped shape.

The tabs 44 of the mounting plate 40 are spaced apart from each other in the circumferential direction, preferably evenly. Alternatively, uneven circumferential spacing could be envisaged. In the exemplary embodiment illustrated, there are eight tabs 44. Alternatively, a greater or lesser number of tabs 44 are possible. For example, two tabs 44 can be envisaged, or at least four tabs 44. Preferably, the number of tabs 44 is at least equal to two. Preferably, the tabs 44 are identical to each other. Alternatively, tabs 44 of a different shape and/or size can be envisaged or formed.

The tabs 44 are offset radially outwardly relative to the mounting skirt 48. Each tab 44 extends protruding obliquely from the radial portion 42. Each tab 44 is bent back inwardly with respect to the radial direction. Each tab 44 radially locally surrounds the holder 32 of the brush 30 and is in radial contact with the lateral wall 38 of the holder 32. The lateral wall 36 of the holder 32 rests radially against the mounting skirt 48 of the mounting plate 40 and the lateral wall 38 rests radially against the tabs 44.

The fastening portion 46 of the mounting plate 40 is force-fitted into the groove 24 of the outer ring 18 of the bearing 12. The fastening portion 46 is made in the form of sectors bent back on themselves in order to conform to the shape of the groove 24. The sectors are spaced apart from each other in the circumferential direction. Alternatively, the fastening portion 46 could be annular. The fastening portion 46 defines the outer diameter of the mounting plate 40. The fastening portion 46 is offset radially outwardly relative to the tabs 44.

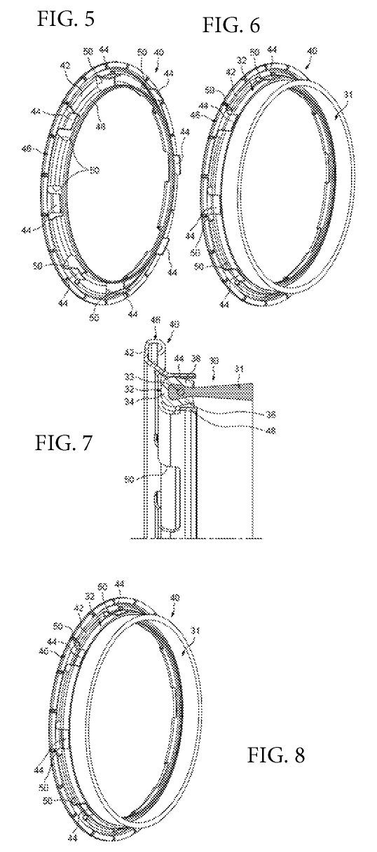

As illustrated more clearly in FIG. 5, a plurality of through-openings 50 is made in the thickness of the radial portion 42 and of the mounting skirt 48 of the mounting plate 40. The openings 50 are formed during the partial cutting of the mounting plate 40 in order to form the tabs 44. The tabs 44 are formed by cutting and bending the mounting plate 40. The openings 50 are spaced apart from each other in the circumferential direction. Each tab 44 is circumferentially aligned with the associated opening 50. The number of openings 50 corresponds to the number of tabs 44. The root of each tab 44 extends from an inner edge of the associated opening 50 that is situated on the radial portion 42.

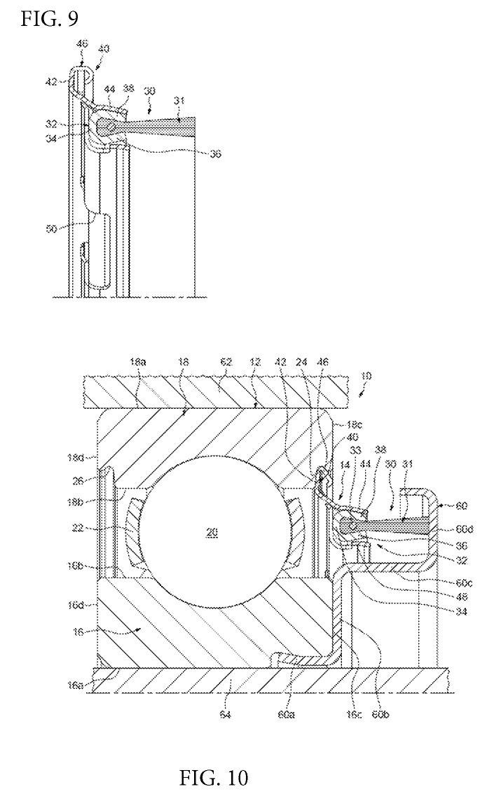

FIGS. 6-9 illustrate the mounting and fastening of the grounding brush 30 on the mounting plate 40. Before the mounting plate 40 is mounted on the bearing 12, the holder 32 of the brush 30 is brought to rest axially against the radial portion 42 of the mounting plate 40 as illustrated in FIGS. 6 and 7. In this position, the tabs 44 of the mounting plate 40 extend axially. The holder 32 is then supported by the mounting plate 40, centered radially between the mounting skirt 48 and the tabs 44. Next, after the holder 32 has been mounted, the tabs 44 of the mounting plate 40 are crimped onto the holder 32, being deformed radially inwards as illustrated in FIGS. 8 and 9 in order to prevent any relative movement between the holder 32 and the mounting plate 40.

The mounting plate 40 is made by cutting and stamping. The mounting plate 40 is made from a conductive material, such as for example aluminum, stainless steel, bronze, copper or another material. Alternatively, the mounting plate 40 can be made from an electrically non-conductive material with a conductive coating or a conductive paint. Preferably, the mounting plate 40 is made in one piece or integral.

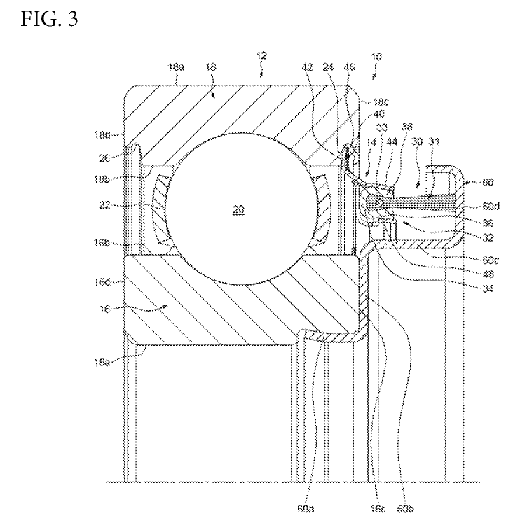

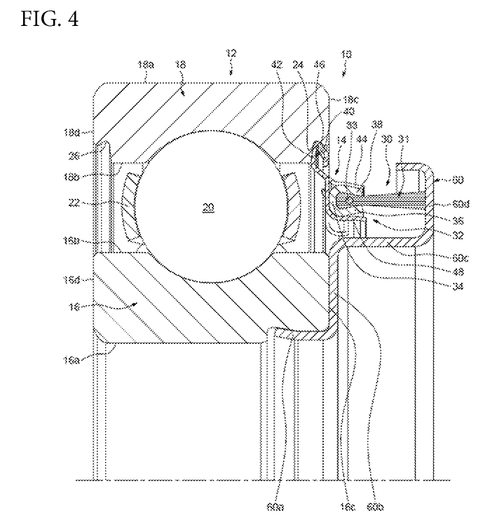

With reference again to FIGS. 3 and 4, the bearing system 10 also comprises a flange 60 fastened to the inner ring 16 of the bearing 12 and with which the free ends of the conductive fibers 31 of the brush 30 are in contact. The flange 60 is a separate element from the inner ring 16.

The free ends of the conductive fibers 31 are axially in contact with the flange 60. The holder 32 of the brush rests axially against the radial portion 42 of the mounting plate 40 and is surrounded by the flange 60.

The flange 60 comprises a first annular axial portion 60a fitted into the orifice or bore 16a of the inner ring 16 of the bearing 12 and an annular radial portion 60b that extends an axial end of the axial portion 60a and rests axially against the front face 16c of the inner ring 16. The axial portion 60a is fitted into a groove (not numbered) made in the orifice/bore 16a of the inner ring 16 of the bearing 12.

The flange 60 also comprises a second annular axial portion 60c axially extending the radial portion 60b axially away from the inner ring 12, and an annular radial collar 60d that extends the second annular axial portion 60c radially outwardly. The axial portion 60c can be provided with through-holes to allow lubricant through.

The free ends of the conductive fibers 31 are axially in contact with the collar 60d of the flange 60. In the exemplary embodiment illustrated, the conductive fibers 31 extend protruding axially relative to the holder 32. The angle between the conductive fibers 31 and the collar 60d of the flange is equal to 90°. Alternatively, the conductive fibers 31 could extend protruding obliquely relative to the holder 32. In another alternative, the collar 60d of the flange 60 may extend obliquely. In both cases, the angle between the conductive fibers 31 and the collar 60d of the flange 60 would be different from 90°.

As illustrated in FIG. 10, the brush system 10 can be mounted inside the orifice or bore of the housing 62 of the associated electric motor and on the rotary shaft 64 of the motor. The bearing 12 is mounted radially between the orifice of the housing 62 and the rotary shaft 64 of the motor.

During the operation of the electric motor, the electrical charges that accumulate on the shaft 64 are dissipated or directed to the housing 62 through the conductive fibers 31, the holder 32 of the brush 30 and the mounting plate 40 of the assembly 14.

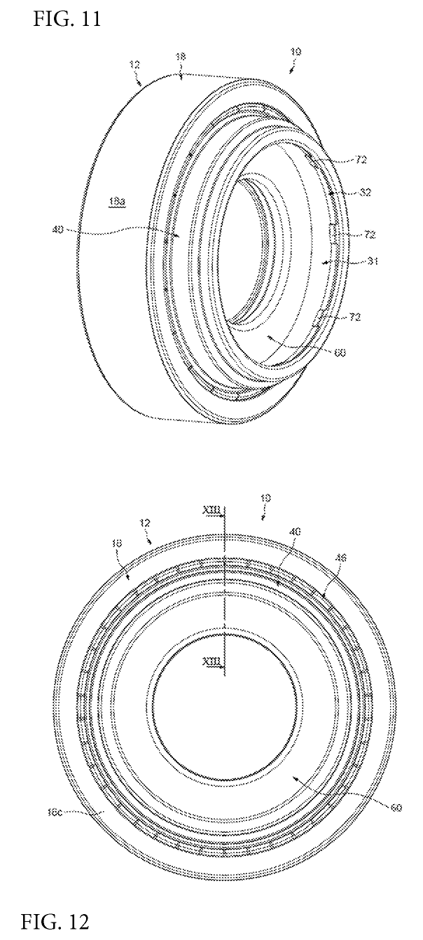

The exemplary embodiment illustrated in FIGS. 11-13, in which identical elements have the same reference signs, differs from the preceding example mainly in that the conductive fibers 31 of the brush 30 extend protruding axially relative to the holder 32 with respect to the axis of the bearing 12. The conductive fibers 31 extend protruding axially toward the bearing 12.

In this example, the mounting plate 40 comprises an annular axial portion 66 extending from the radial portion 42, and an annular mounting skirt 68 extending axially from a small diameter edge of the radial portion 42, and an annular radial portion 70 extends radially inwardly from the mounting skirt 68. The axial portion 66, the radial portion 70 and the mounting skirt 68 are situated or disposed axially outside of the bearing 12. The axial portion 66 has a stepped shape. The axial portion 66 can be provided with through-holes to allow lubricant through. The holder 32 of the brush 30 rests axially against the radial portion 70 axially toward the rolling elements 20.

The mounting plate 40 also comprises a plurality of tabs 72 for retaining the brush 30 extending from the radial portion 70. The tabs 72 are spaced apart from each other in the circumferential direction, preferably evenly. Alternatively, the circumferential spacing can be uneven or staggered. In the exemplary embodiment illustrated, there are eight tabs 72. Alternatively, a greater or lesser number of tabs 72 can be envisaged or provided.

The tabs 72 are offset radially inwardly relative to the mounting skirt 68. Each tab 72 extends protruding obliquely from the radial portion 70. Each tab 72 is bent back outwardly with respect to the radial direction. The mounting skirt 68 surrounds the holder 32 of the brush 30 and is in radial contact with the lateral wall 38 of the holder 32. Each tab 72 is in radial contact with the lateral wall 36 of the holder 32. The holder 32 is centered radially between the mounting skirt 68 and the tabs 72 of the mounting plate 40. The tabs 72 are formed by cutting and bending the mounting plate 40. The mounting plate 40 is made in one piece.

In this example, the flange 60 comprises just the first annular axial portion 60a fitted into the orifice/bore 16a of the inner ring 16 and the annular radial portion 60b, which has a larger radial dimension.

The free ends of the conductive fibers 31 are axially in contact with the radial portion 60b of the flange 60. In the exemplary embodiment illustrated, the conductive fibers 31 extend protruding axially relative to the holder 32. The angle between the conductive fibers 31 and the radial portion 60b of the flange is equal to 90°. Alternatively, the conductive fibers 31 could extend protruding obliquely relative to the holder 32. In another alternative, the radial portion 60b of the flange 60 could extend obliquely. In both cases, the angle between the conductive fibers 31 and the radial portion 60b of the flange 60 would be different from 90°.

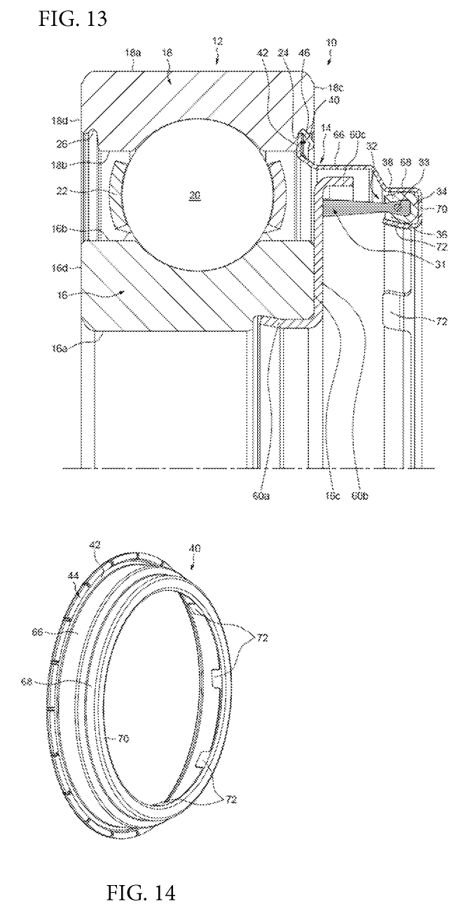

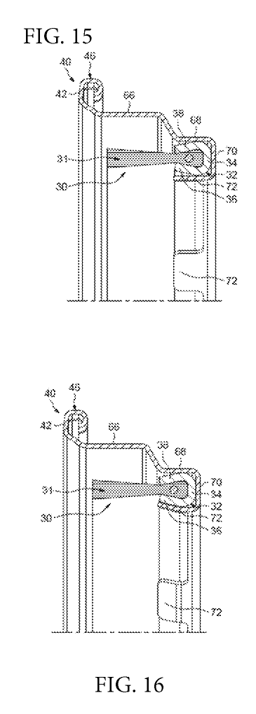

FIGS. 14-16 illustrate the mounting and fastening of the grounding brush 30 on the mounting plate 40. Before the mounting plate 40 is mounted on the bearing 12, the holder 32 of the brush 30 is brought to rest axially against the radial portion 70 of the mounting plate as illustrated in FIG. 13. In this position, the tabs 72 of the mounting plate 40 extend axially. The holder 32 is then supported by the mounting plate 40, centered radially between the mounting skirt 68 and the tabs 72. Next, after the holder 32 has been mounted, the tabs 72 of the mounting plate 40 are crimped onto the holder 32, being deformed radially outwardly as illustrated in FIG. 16.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A bearing system comprising:
a bearing including an inner ring and an outer ring, at least one of the inner and outer rings being capable of rotating relative to the other one of the inner and outer rings; and
a grounding brush assembly including a brush having a holder and a plurality of conductive fibers, the conductive fibers being mounted inside the holder and extending axially relative to the holder, and a mounting plate on which the holder is mounted, the mounting plate being fastened to one of the inner and outer rings of the bearing.

2. The system according to claim 1, wherein:
the outer ring of the bearing has a front face and the inner ring of the bearing has a front face; and
the grounding brush assembly extends partially outside of the bearing, a part of the assembly positioned outside of the bearing being offset radially inwardly relative to the front face of the outer ring and offset radially outwardly relative to the front face of the inner ring.

3. The system according to claim 1, wherein the conductive fibers of the brush of the grounding brush assembly protrude from the holder axially away from the bearing or axially toward the bearing.

4. The system according to claim 1, wherein the brush holder of the grounding brush assembly defines an axially-facing open channel.

5. The system according to claim 1, wherein the mounting plate of the grounding brush assembly includes a mounting skirt and a plurality of tabs for retaining the brush holder, the holder being centered radially between the mounting skirt and the retaining tabs.

6. The system according to claim 1, wherein the mounting plate of the grounding brush assembly is fastened directly to the inner ring of the bearing or directly to the outer ring of the bearing without an interposing intermediate element.

7. The system according to claim 1, wherein:
a groove is formed in a bore of the outer ring of the bearing or formed on an outer surface of the inner ring of the bearing; and
the mounting plate of the grounding brush assembly is fastened inside the groove.

8. The system according to claim 1, further comprising a flange fastened to the other one of the inner ring and the outer ring of the bearing, the conductive fibers of the brush of the grounding brush assembly having free ends in contact with the flange.

9. The system according to claim 8, wherein the flange includes a collar or a radial portion, the free ends of the conductive fibers being in contact with the collar or the radial portion.

10. An electric motor comprising:
a housing;
a shaft; and
at least one bearing system according to claim 1 mounted radially between the housing and the shaft.
